(19) United States
(12) Patent Application Publication
(10) Pub. No.: US 2003/0074399 A1
(43) Pub. Date: Apr. 17, 2003

(54) System and process for user-controlled single-action personal information transfer at internet web sites using extensible markup language

(76) Inventor: Girish Altekar, Austin, TX (US)

Correspondence Address: GIRISH M ALTEKAR, 606 W LYNN #20, AUSTIN, TX, 78703, US

(21) Appl. No.: 10/096,069

(22) Filed: Mar. 13, 2002

Related U.S. Application Data
(63) Continuation of application No. 09/708,394, filed on Nov. 9, 2000.

(51) Int. Cl. G06F 15/16

(52) U.S. Cl. 709/203; 709/219

(57) ABSTRACT

The invention allows web site visitors to provide information to the web sites of their interest in an easy and convenient manner. At all times, the users alone are in control of the information provided. The invention is based on the idea of allowing users to create their personal information databases in human readable XML documents, which can then be easily interpreted and processed on the server side.

### CROSS-REFERENCE TO RELATED APPLICATIONS

This application is a continuation of an application Ser. No. 09/708,394 entitled “System and process for user-controlled single-action personal information transfer at Internet web sites using Extensible Markup Language”, filed Nov. 11, 2000, by Altekar.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

The field of endeavor of this invention is Internet based e-commerce. The invention allows users to provide all kinds of personal information to the web sites of their interest in an easy and convenient manner. At all times, the users alone are in control of the information provided.

While some vendors such as Microsoft, AOL, and more recently Sun Microsystems, provide users single sign-on and e-commerce capabilities centered around their basic information (name, address, credit card), this invention is a new and unique method that is a significant improvement on the existing capabilities.

The current approaches today require users to signup with a service provider (like Microsoft or Sun) by providing their personal information. The service provider gives the user a single sign-on that identifies the user to all merchants that belong to that service provider's merchant club. When a user wishes to execute a transaction with that merchant, the merchant and the service provider negotiate for the user's information, with the attendant extraction of transaction and service costs by the service provider. Here are the details on these currently known approaches.

Microsoft Passport—www.passport.com

Microsoft's Passport is an on-line identity that is issued to members. This identity can subsequently be used to complete financial transactions. As can be seen from the following patent application titled “System and method facilitating personal electronic financial transactions”, (Publication #20020026396), the Passport system can be used to create a system for facilitating personal electronic transactions.

The abstract for this invention claims a data network to store and exchange a consumer's financial information with a related entity for the purposes of executing a transaction.

While Passport and this invention both enable quick transfer of personal information, the following Microsoft Passport attributes differentiate this invention from the Passport system.

1. Passport asks users to become members. This invention does not.

2. Passport invites them to store their personal information at a Microsoft data center. This invention does not, allowing users to store their information on their own desktops.

3. Passport can only deal with basic personal and financial information. This invention allows user to create databases of various kinds of personal information so they can be reused effectively.

4. When a transaction is executed, Passport negotiates the exchange of the user's information on his/her behalf. This invention lets the user do that directly.

5. Passport controls what happens to the data. The user cannot retrieve, delete or reuse the data. This invention empowers users to have complete ownership of their information.

6. Passport asks merchants to become members of their business organization, with its attendant rules and limitations. In this invention, merchants simply apply the invention, retaining full control of their own business functions.

Amazon 1-Click

Amazon's 1-Click is a service that is available at Amazon and related stores where Amazon stores credit card and other information on a user's first interaction with the web site and subsequently reuses it every time the user transacts business with Amazon or an affiliated site. Most of the differentiating features described with Passport also apply, namely:

1. Only Amazon members can use the 1-click system and only at Amazon and Amazon related sites.

2. The information and history is stored at an Amazon data center.

3. Only basic, purchase transaction oriented information is supported.

4. Amazon is the party negotiating the exchange of information on user's behalf.

5. The users cannot retrieve or delete their information.

6. Only networked merchants can use the service.

AOL Quick Checkout

AOL Quick Checkout service yet another service like the Amazon's 1-Click service. The same limitations apply.

Sun Microsystem—Liberty Project

Sun's Liberty project, about which details are not yet known, is known to deal with a “federated” model which attempts to create a mechanism just like the above except that it is expected to be more ubiquitous by giving more players a stake in the building this consumer database. Not much is known about the mechanisms about the Liberty project.

Gator.com

Gator is probably the invention that comes closest in function to this invention but even then there are significant areas of differences. Gator allows a user to download a software application that then assists the user in filling out forms and logging into various sites on the Internet. The differentiation in the mechanism is multifold:

1. This invention does not ask the user to download any computer software.

2. Gator can at best deal with the basic information. This invention allows the users to create personal databases of varying kinds.

3. Gator claims to not store user's information and yet there is always a live path to Gator involved in any transaction. This invention eliminates any necessity of interaction with anyone except the user and the merchant they are dealing with.

4. Gator software codes do not interact with the target web site. This invention must be installed on the merchant web sites in order for users to interact with it.

Various

In addition to these above, there are many other similar applications that provide a data store and reuse functionality that claims to ease the job of a user.

This invention is the only invention that uses XML to create common vocabularies that allow users to create personal information databases on their own computers that they can then transmit and reuse at any enabled site. In providing this set of features together, this invention and the set of applications built on top, are unique.

### BRIEF SUMMARY OF THE INVENTION

This application covers the system and the process for enabling user-controlled single-action personal information transfer. This application also covers the application of the system and the process to the specific vocabularies and processes that allow web site visitors to perform the following activities on the Internet in the most efficient manner possible:

1. Register personal information at a web site

2. Maintain login information for hundreds of sites

3. Search for best air travel deals, make reservations

4. Pay for internet purchases using credit cards

5. Register business information at a web site

6. Search for jobs

7. Make rental car reservations

8. Make hotel reservations

9. Receive and exchange electronic product receipts

10. Search for auto insurance

11. Manage auto information

12. Manage online bill payments

Problems Solved

This invention solves problems associated with the currently available competing information exchange mechanisms, in a unique, comprehensive, and a significantly improved manner. The problems that this invention collectively solves are:

1. Users cannot quickly and rapidly transfer, in a generalized fashion, many kinds of data. The data extends beyond just personal information (name, address, credit card) and includes information that users commonly exchange with many merchants, government agencies and other entities that they do business with.

2. Users cannot effectively reuse their own information at multiple sites or multiple times at the same site.

3. Users must use merchants that belong to a “federation” and cannot interact with merchants that choose not to belong to any such federation.

4. Users must provide sensitive information to intermediaries (service providers) and thus are no longer in control of their information. They are also captive to higher prices and other measures that the service provider might subsequently impose.

5. Users cannot control if the information is subsequently resold to other parties.

Solution

The dominant existing solution for such information transfer is the manual retyping of all information at all web sites. This is of course cumbersome, irritating and inefficient. And yet large percentage of Internet transactions are currently conducted in this crude fashion simply because there are no other user-friendly alternatives available to users.

Existing solutions eliminate the problem of manual retyping but introduce control issues by becoming the intermediary or a broker of the user information. This invention is unique in that it eliminates such manual retyping while eliminating the need for the intermediary function associated with a “federated” model. This invention creates a universal method using which user's can store their information locally and deposit it to requesting web sites on demand in a single action. The users are in full control of their data at all times and no other parties are involved in this transaction.

The invention creates the system and the method by which users of the system create their own information repositories, called QPIDs (Quick Personal ID), on their local computer. When users wish to provide a set of personal information items to a particular web site, they either type the name of a specific QPID file in the dialog box or drag-and-drop their QPID on the dialog box. The underlying software extracts the information from the QPID and delivers it to the intended web site where the server side software of this invention interprets the data and performs the required processing.

Twelve types of QPIDs as described above are defined and implemented.

### BRIEF DESCRIPTION OF THE SEVERAL VIEWS OF THE DRAWING

FIG. 1. The current method of personal information exchange among web sites and users using third party intermediaries.

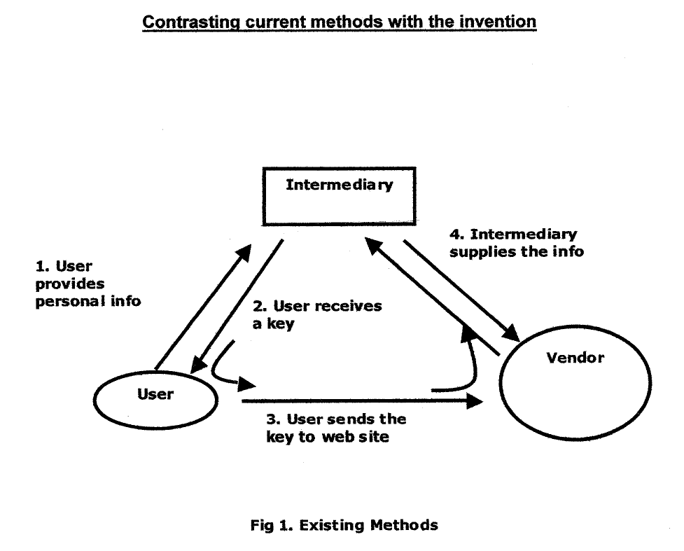

FIG. 2. The proposed method of personal information exchange between users and web sites.

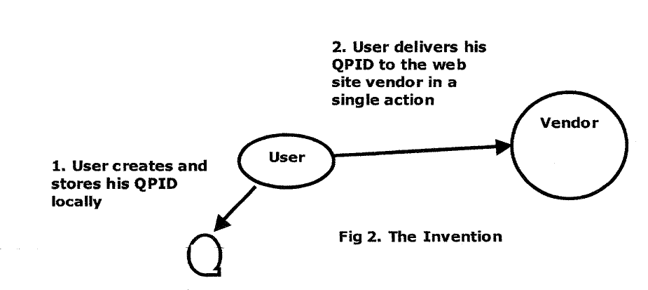

### DETAILED DESCRIPTION OF THE INVENTION

The invention consists of three software components.

The first component is a file called the QPID that the user creates on his or her personal computer using the tools provided. The QPID is a human readable text file encoded in XML vocabularies defined for a particular application. The vocabularies define the content of the QPID and can be extended as appropriate. A QPID contains the data a user might wish to provide to a web site and once created can be used multiple times at different QPID compliant sites.

The second component is an applet that is embedded on the registration page of the web site being visited. The applet informs the user that the web site accepts QPIDs and invites the user to click at an appropriate place to activate the applet to submit their QPID. When the user clicks on the suggested link, the applet is activated and asks the user to either type in the name of their QPID file, or select the name with the help of a browsing control.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A system and process for user-controlled single-action personal information transfer at Internet web sites using Extensible Markup Language comprising
a. A set of XML vocabularies that provide the format in which users can store different kinds of personal information in a structured form
b. A file, known as QPID, in which a user stores the said information about themselves conforming to the said vocabulary.
c. A browsing window that enables a user to specify a particular QPID in order to send the said QPID to a web site
d. A software program that resides on a web site which when activated by a user will cause the said browsing window to appear on the user's desktop
e. A software program that is installed on the web site web server, which will receive the said QPID, will interpret the said QPID, and will provide the information contained therein to an application on the web site that queries the server for the said information.
whereby the said user is able to transfer his varied personal information to the said web site vendor in a single-action without having to reenter the said information on the said web site, and
whereby the said information remains under the said user's control and possession all the time until such time as he delivers the information to the said web site.

2. Provide personal information at a web site. This application allows a user to provide his or her name/address information to a web site. This application is unique and different from others because the user creates the personal information database on his/her PC once using a structured XML vocabulary and uses it instantly at multiple web sites. No intermediaries are involved and the user can create multiple identies if they choose to do so.

3. Maintain login information for hundreds of sites. This application allows users to create a login information database on his/her PC once using a structured XML vocabulary and to reuse it instantly at appropriate web sites. The uniqueness is that there is no restriction on which web sites the user can login into, they don't have to remember names and passwords, and this information is stored permanently so is available even if the user's PC applications are overwritten.

4. Search for best air travel deals, make reservations. This application allows the user to create an itinerary and to seek out the best air travel deal for that itinerary from multiple travel sites without having to retype it at each different site. The user can quickly modify the travel QPID for another itinerary. No other mechanism offers users a better way to obtain the best deals and to make reservations.

5. Pay for Internet purchases using credit cards. This application enables users to make on-line purchases using their credit cards. The uniqueness of this application is derived from the user's ability to create a safe and secure repository of multiple credit card QPIDs on their PC and to use them rapidly and quickly, in an error free manner.

6. Register business information at a web site. This application allows a user to provide his or her business name/address information to a web site. This application is unique and different from others because the user creates the business information database in his/her PC once using a structured XML vocabulary and uses it instantly at suppliers, vendors and partners. No intermediaries are involved and the user can create multiple identies if they choose to do so. In addition, users can specify preferred modes of contact and communication.

7. Search for jobs. The resume QPID enables the user to create a structured repository of his or her job search related information so they can reuse it instantly at all job web-sites. This application is unique in that no one today offers another mechanism for standardizing and structuring employment information that can be rapidly reused to seek jobs at various employment sites.

8. Make rental car reservations. This application allows the user to create a car rental QPID that stores both the rental car preferences and an itinerary (that may or may not change) and to seek out the best car rental car rental deal for that itinerary from multiple travel sites without having to retype it at each different site. The user can quickly modify the car rental QPID for another itinerary. No other mechanism offers users a better way to obtain the best deals and to make reservations.

9. Make hotel reservations. This application allows the user to create a hotel reservation QPID that stores both the room preferences and an itinerary (that may or may not change) and to seek out the best hotel deal for that itinerary from multiple travel sites without having to retype it at each different site. The user can quickly modify the hotel QPID for another itinerary. No other mechanism offers users a better way to obtain the best deals and to make reservations.

10. Recieve and exchange electronic product receipts. Product receipts today are not managed electronically in a structured format creating much pains for consumers when they wish to obtain customer service, technical or warranty support. This is the only application that enables users to receive/store a product receipt for a purchased product or service on his/her PC once using a structured XML vocabulary and to reuse it instantly at vendor web-sites to obtain the service, warrantly and product support.

11. Search for auto insurance. Consumers shop for auto insurance often but there are no means of doing this in an efficient manner without going through an intermediary. This unique application enables a user to create a database of his/her auto insurance information on his/her PC once using a structured XML vocabulary and to reuse it instantly at appropriate web sites to obtain the best price quotes and to purchase said insurance.

12. Manage auto information. Information about a user's car is fairly static and reused at multiple places. At garage shops, at State Motor Vechicle departments for inspections, repairs, resale, etc. The uniqueness of this application is derived from the user's ability to create an information database of his/her automobiles on his/her PC once using a structured XML vocabulary and to reuse it instantly at appropriate web sites to register, inspect, repair and to buy/sell the automobile.

13. Manage online bill payments. Each user has a unique of set of payees that they deal with on an ongoing basis. Rather than be restricted to a single bank's on-line bill payment mechanism, this application uniquely allows a user to create a database of his/her bill payee information on his/her PC once using a structured XML vocabulary and to reuse it instantly at any bank or payment site to make the necessary payments. =pg,36
